(19) United States
(12) Patent Application Publication
(10) Pub. No.: US 2006/0187593 A1
(43) Pub. Date: Aug. 24, 2006

(54) Turbine energy generating system

(76) Inventor: Imad Mahawili, Grand Haven, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/358,577

(22) Filed: Feb. 21, 2006

Related U.S. Application Data
(60) Provisional application No. 60/655,168, filed on Feb. 22, 2005.

(51) Int. Cl. H02H 7/06

(52) U.S. Cl. 361/20

(57) ABSTRACT

A turbine energy generating system includes a combustion chamber for converting fuel into energy by igniting an air and fuel mixture, a turbine for converting energy produced by the combustion chamber into mechanical energy, and a generator for converting mechanical energy produced by the turbine into electrical energy in the range of 1 to 15 kilowatts.

This application claims priority to U.S. provisional application entitled TURBINE ENERGY GENERATING SYSTEM, filed Feb. 22, 2005, Ser. No. 60/655,168, by Applicant Imad Mahawili, Ph.D, which is herein incorporated by reference in its entirety.

### TECHNICAL FIELD AND BACKGROUND OF THE INVENTION

The present invention relates generally to turbine energy generating systems. More specifically, the present invention relates to a turbine energy generating system that can be used in a residential setting to supplement or substitute for a conventional utility electrical supply system and, further, can be used as part of an energy supply network.

Today existing electric generating technologies include large scale steam turbines producing electricity with a relatively low efficiency rate. The large scale steam turbines often emit undesirable byproducts, such as sulfur oxides, nitrous oxides, ash, and mercury. Additionally, these large scale steam turbines emit a large amount of heat, which is generally released into lakes often disrupting the environment.

More recently it has been found that smaller scale turbines, such as micro-turbines, fueled by natural gas can operate with greater efficiency. During operation, the micro-turbines do not pollute to the same degree as large scale steam turbines and instead emit elements such as carbon dioxide and water, with only very low amounts of nitrogen oxides. Additionally, the heat recovery from operation of the micro-turbines is useful for heating water.

In many parts of the world there is a lack of electrical infrastructure. Installation of transmission and distribution lines to deliver the product to the consumer is very costly, especially in third world countries. Moreover, the electrical infrastructure in many countries is antiquated and overworked resulting in “brownouts” and “blackouts.”Consequently, there is a need for an energy generating system that can produce energy in a stand alone system or that can be integrated into existing systems.

### SUMMARY OF THE INVENTION

Accordingly, the present invention provides a turbine energy generating system that can be used independently of a conventional utility electrical supply system or can be integrated into a conventional electrical supply system to supplement the system or contribute to the energy supply as part of a network.

In one form of the invention, a turbine energy generating system includes a combustion chamber for converting fuel into gaseous heat energy, such as steam, by igniting an air and fuel mixture, a turbine for converting the energy produced by the combustion chamber into mechanical energy and a generator for converting the mechanical energy produced by the turbine into electrical energy.

The turbine energy generating system could be designed to produce 1 to 15 kilowatts.

In another aspect of the invention, the generator may be an electric generator producing alternating electric current during operation of the turbine energy generating system. The fuel for the turbine energy generating system may include any of the following: diesel, gasoline, naphtha, propane, methane, natural gas, wood, coal, biomass, lawn clippings, and oil, and combustible recyclables, such as tires, plastics, paper products, biogas, and biodiesels.

According to another aspect of the invention, the turbine energy generating system further includes an exhaust passage downstream from the turbine delivering high temperature exhaust air from the turbine and a heat exchanger receiving the high temperature exhaust air for heat transfer. An air conditioning system may also be coupled to the heat exchanger. A water heating system for converting tap water into hot water may be coupled to a heat exchange exhaust for releasing lower temperature exhaust air. In one form of the invention the combustion chamber could be cooled with water with a heat exchange surface that induces water boiling into steam. Such generated steam could then be condensed yet in another heat exchanger to produce liquid potable water from a variety of initial cooling water sources. This could be quite a novel advantage for the application of such turbine electric systems, whether using steam to generate the turbine driving energy or natural gas combustion, where safe drinking water is desired.

In yet another aspect of the invention, the turbine energy generating system may include a central controller and a plurality of turbine energy generating systems connected over a network for communications. The central controller and the plurality of turbine energy generating systems may communicate information such as usage and spending through an electric grid. The central controller may communicate with at least one of the plurality of turbine energy generating systems to return power to the electric grid. Additionally, the central controller may enable a one turbine energy generating system to provide a power load to another turbine energy generating system through the electrical grid. The network may be an internet network using policy parameters from power wheeling standards.

Another aspect of the invention, the turbine energy generating system may be portable or may be compatible for integration with a plurality of energy systems to provide power to an electrical distribution system and further may be configured for integration into a heating system, a cooling system and/or a water heating system.

### BRIEF DESCRIPTION OF THE DRAWINGS

FIG. 1 is a schematic drawing of a turbine energy generating system according to the present invention;

FIG. 2 is a schematic diagram of the turbine energy generating system of FIG. 1 attached to a switchboard controller and meter;

FIG. 3 is a schematic diagram of the turbine energy generating system of FIG. 2 attached to a heating system;

FIG. 4 is a schematic diagram of the turbine energy generating system of FIG. 3 attached to an air conditioning system;

FIG. 5 is a schematic diagram of the turbine energy generating system of FIG. 4 connected to a hot water heater;

FIG. 6 is a schematic diagram of the turbine energy generating system of FIG. 5 connected to a water system, such as a hot water tank or water boiler and condenser to produce potable water;

FIG. 7 is a schematic diagram of the turbine energy generating system according to the present invention integrated into a house;

FIG. 8 is a schematic diagram of the relationship between the house with the turbine energy generating system and an electric generation power plant;

FIG. 9 is a schematic diagram of the relationship between a plurality of houses with turbine energy generating systems, a grid, and the electric generation power plant;

FIG. 10 is a schematic diagram of the relationship between the plurality of houses with turbine energy generating systems, a grid, the electric generation power plant, and a fuel source;

FIG. 11 is a schematic diagram of the relationship between a plurality of houses with turbine energy generating systems, a grid, the electric generation power plant, and a central controller over a network;

FIG. 12 is a schematic diagram of the relationship between a plurality of houses with turbine energy generating systems, a grid, the electric generation power plant and a central controller over a network using power wheeling standards;

FIG. 13 is a schematic diagram of the system of FIG. 12 with additional sources of fuel;

FIG. 14 is a schematic drawing of another turbine energy generating system according to the present invention;

FIG. 15 is a side view of one embodiment of the turbine of FIG. 1;

FIG. 16 is a perspective view of the turbine of FIG. 15 with the cover removed;

FIG. 17 is a perspective view of the turbine wheel;

FIG. 18 is a cross-section of the turbine; and

FIG. 19 is cross-section along line XIX of FIG. 15.

### DESCRIPTION OF THE PREFERRED EMBODIMENT

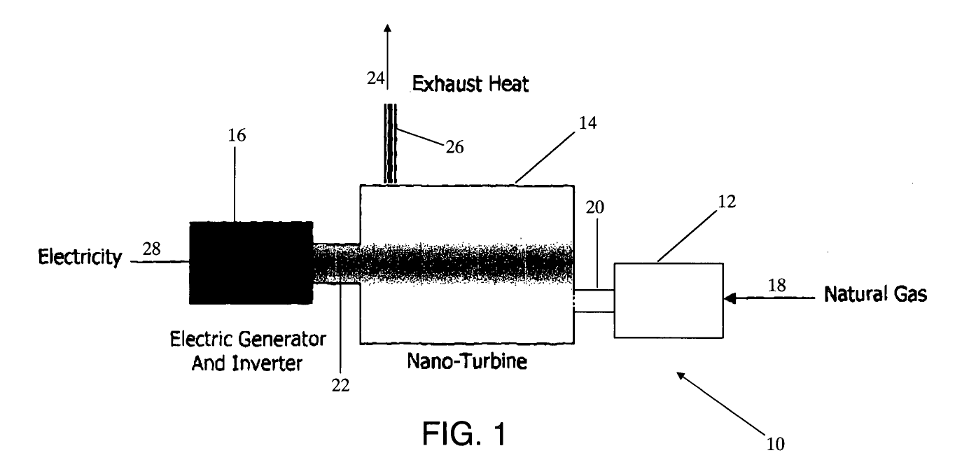

Referring now to the figures, FIG. 1 is a schematic drawing of a turbine energy generating system 10 according to the present invention. As will be more fully described below, turbine energy generating system 10 of the present invention converts fuel 18 into electrical power 28 that can be used immediately, stored for later use, or delivered to a network for distribution within the network, such as an electric company grid.

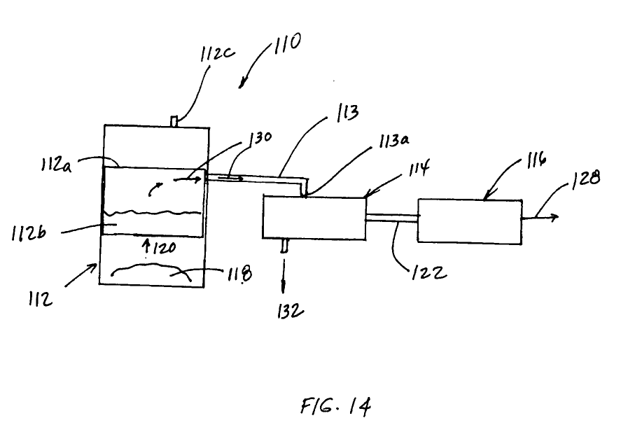

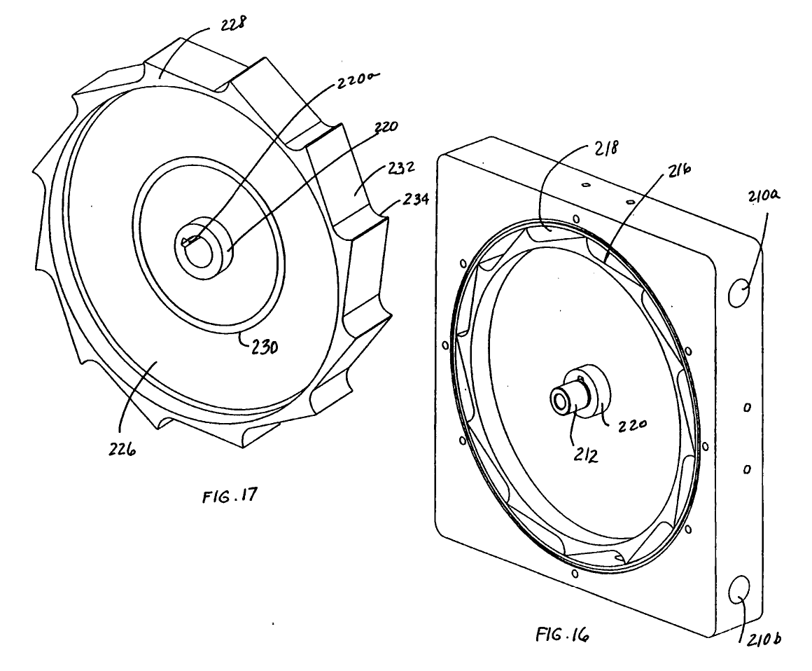

Turbine energy generating system 10 includes a combustion chamber 12, a turbine 14, and a generator 16, such as an electric generator and inverter. Turbine energy generating system 10 may be portable and easily transportable between locations and buildings. Turbine 14 is preferably dimensioned such that it may portable and has an output in a range to 1 to 15 kilowatts and more preferably in a range of 5 to 10 kilowatts. In addition turbine 14 may be configured to have an efficiency of at least 40%, more preferably at least 50%, and more typically, in a range of 50% to 60%. Further details of a suitable turbine 14 are provided in reference to FIGS. 15-18. Additionally, turbine energy generating system 10 is compatible for integration with other energy systems and systems requiring energy. This will be discussed in more detail below.

Fuel 18 is provided to combustion chamber 12, which converts the fuel into gaseous heat energy 20 by igniting an air and fuel mixture. Gaseous heat energy 20 may include steam. For example, as will be described in reference to a later embodiment, chamber 12 may include water, which is heated and then circulated to produce steam, including high pressure steam. Fuel 18 may include diesel, gasoline, naphtha, propane, methane, natural gas, wood, coal, biomass, lawn clippings, oil, combustible recyclables, such as tires, plastic, and paper products, biogas, or biodiesels.

Gaseous heat energy 20 is provided to turbine 14, which converts the gaseous heat energy into mechanical energy 22. In addition, during the conversion of the gaseous heat energy 20 exhaust heat 24 is also produced. Exhaust heat 24 is released out of an exhaust passage 26 downstream from turbine 14. Exhaust heat 24 may be a high temperature exhaust air.

Generator 16 converts mechanical energy 22 into electrical energy 28. Generator 16 may include a rotating rotor and a stator. The rotor may be a permanent magnet positioned rotatably within the stator and rotates relative to the stator during operation of turbine 14. Mechanical energy 22 can be transferred to a shaft from turbine 14 to the rotor, so that the shaft, turbine 14 and rotor of generator 16 rotate in unison at speeds, for example, of up to 90,000 rpms or more.

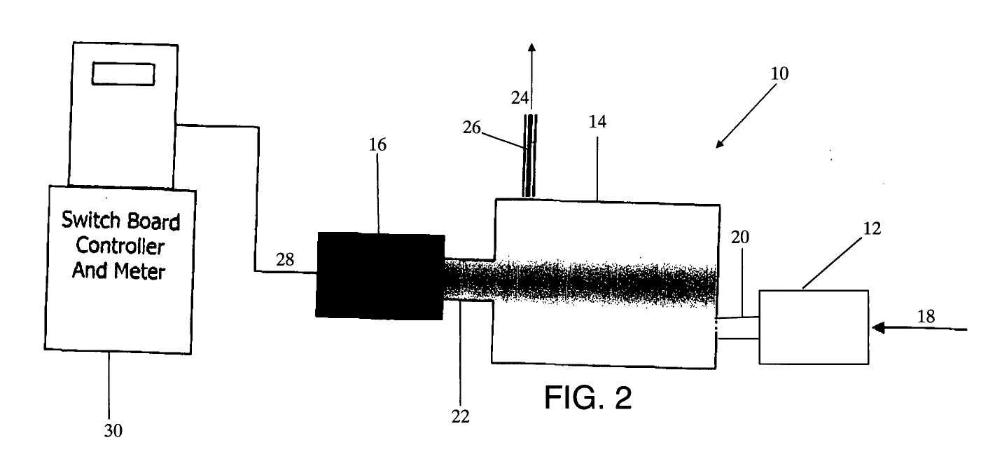

Referring to FIG. 2, turbine energy generating system 10 as illustrated in FIG. 1 may be attached to a switchboard controller and meter 30. Switchboard controller and meter 30 assists in the distribution of electric power to a building or location. Generally, the instant load from turbine energy generating system 10 follows controller 30 of a standard home electrical box. Turbine energy generating system 10 is easily compatible with all standard configurations for electrical box controllers 30.

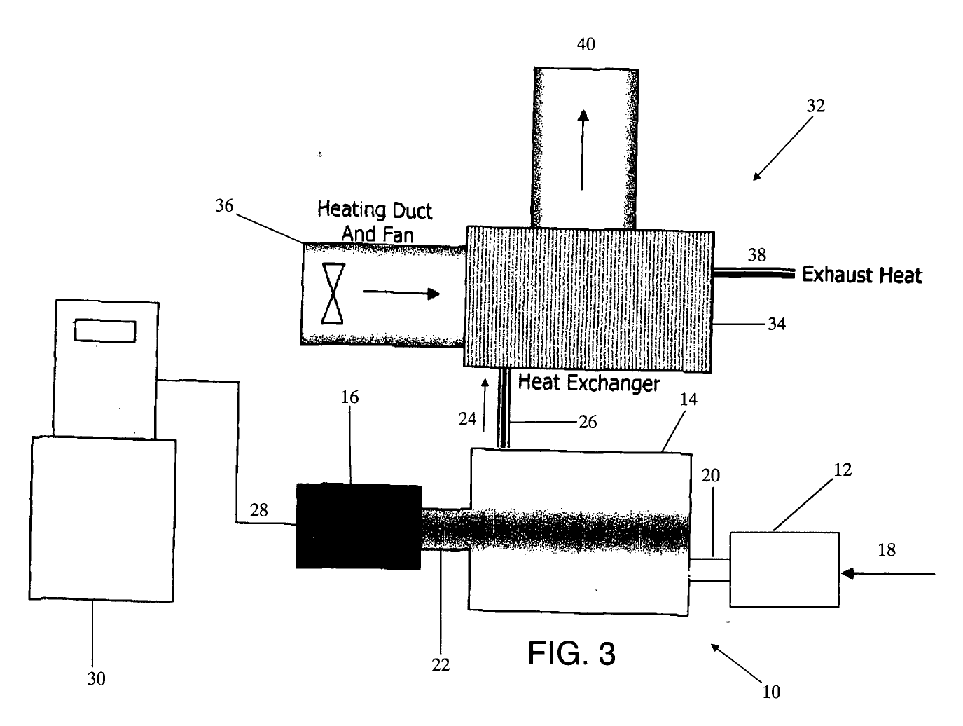

As best seen in FIG. 3, turbine energy generating system 10 of FIG. 2 may be additionally attached to heating system 32 so that exhaust heat 24 of energy generating system 10 may be used in a heating system 32. Heating system 32 may include heat exchanger 34 coupled to a heating duct and fan setup 36. Heat exchanger 34 may use exhaust heat 24 to provide exhaust heat 38 and/or output heat 40 for a location or building. Heat exchanger 34 receives high temperature exhaust air 24 from exhaust passage 26 downstream from turbine 14 for heat transfer. In this manner, turbine energy generating system 10 may assist with heating requirements for a location or building.

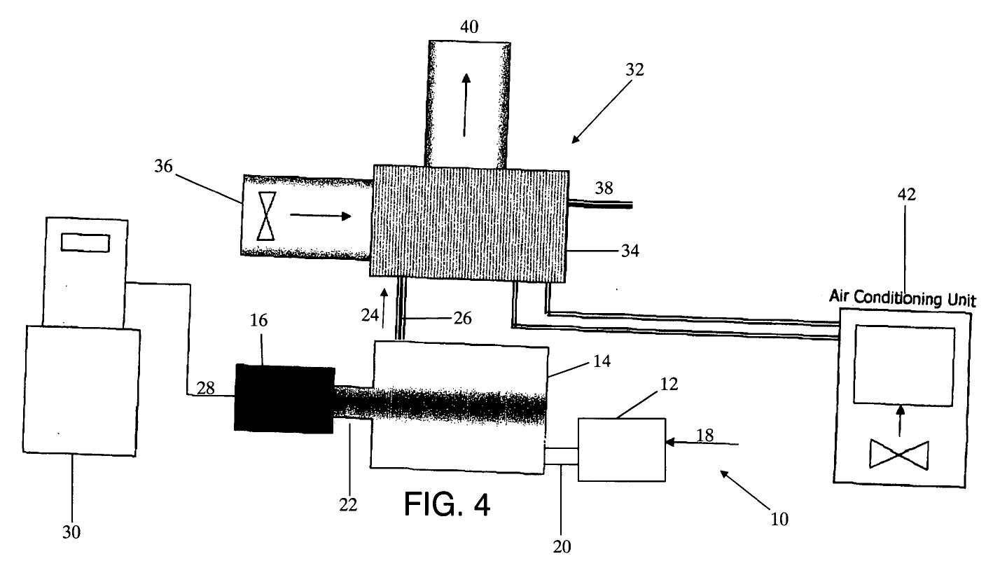

FIG. 4 is a schematic diagram of turbine energy generating system 10 as illustrated in FIG. 3 attached to air conditioning system 42. Accordingly, turbine energy generating system 10 may satisfy or complement the cooling requirements for a location or building.

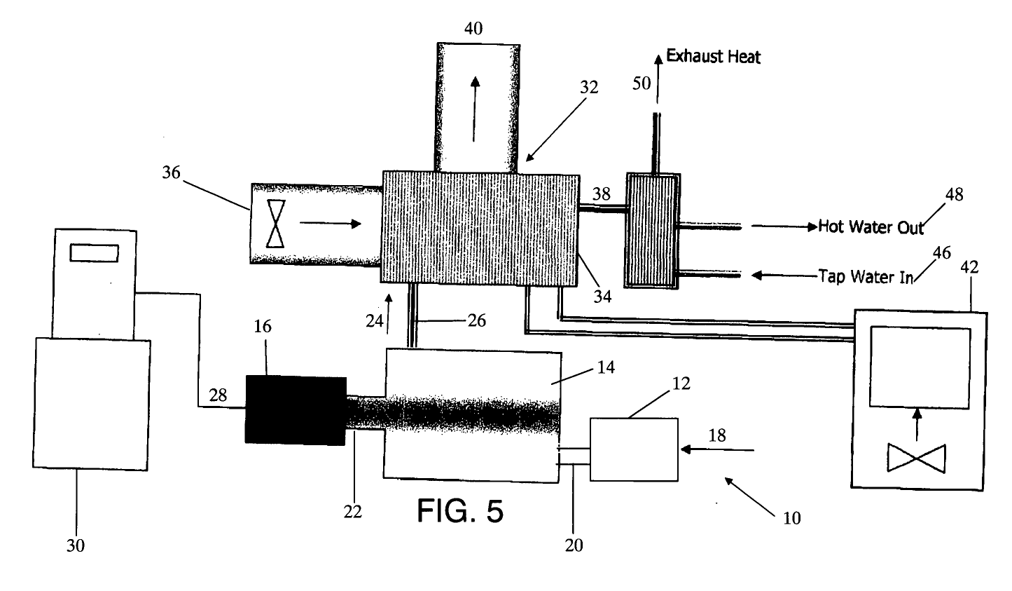

Additional components that may be added to system 10 include a water system 44. Referring to FIG. 5 the exhaust heat of heating system 32 of FIG. 4 may be coupled to a water system 44. For example, the water system may comprise a hot water heater or water boiler 44 and condenser to produce potable water. Water heater 44 is connected to exhaust heat 38 from heat exchanger 34. Water heater 44 receives water 46, and using the exhaust beat 38, produces hot water 48 and optionally exhaust heat 50.

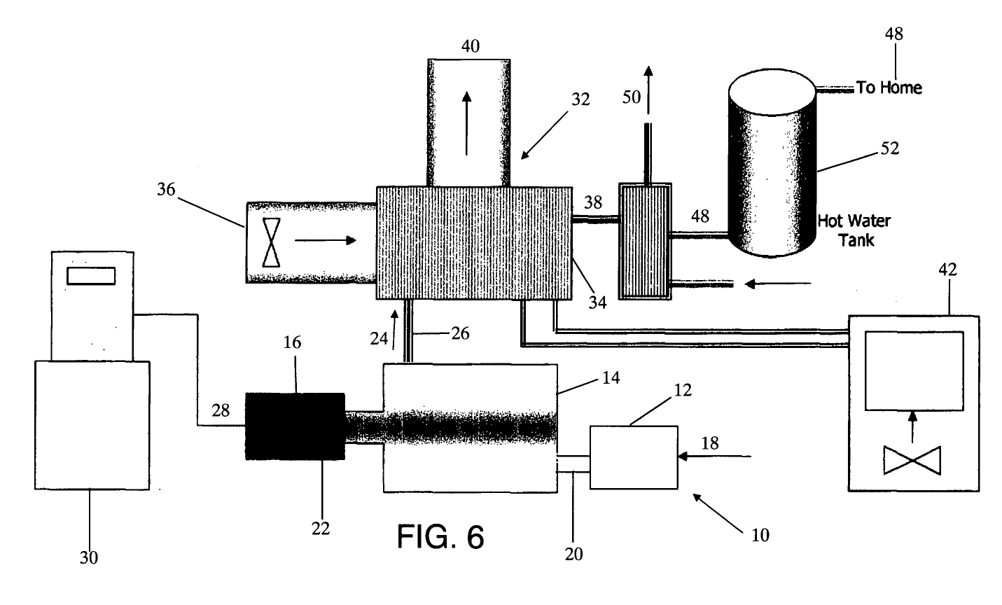

Referring to FIG. 6 exhaust heat 50 of hot water heater or boiler 44 of FIG. 5, may be connected to a hot water tank 52, or as noted above to a condenser. Hot water tank 52 provides storage for hot water 48 from hot water heater 44 for a location or building. The condenser condenses the steam produced by the boiler into potable water. The resulting system shown in FIG. 6 herein after is referred to as home energy system 60. It should be noted, that home energy system 60 is only illustrative and not meant to be limiting of the application of energy system 60 to houses, but may also apply to other types of buildings, structures and locations. Further, home energy system 60 may include integration of all or some of these systems: electrical system switch board and meter 30, heating system 32, air conditioning system 42, water system 44, with a hot water heater or boiler, and hot water storage tank 52 or a condenser for producing potable water, as noted above. It should be appreciated that other types of systems related to houses, buildings, locations or structures can be integrated with energy system 10, while keeping within the spirit of the invention. The integration of home energy system 60 is discussed in further detail below.

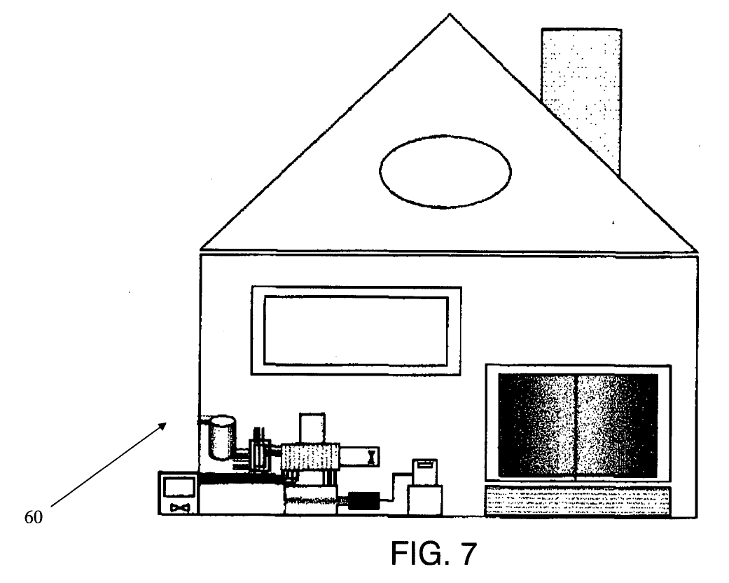

As generally noted above, energy system 60 may be integrated into a house 58, illustrated in FIG. 7, to supplement or substitute an existing energy system. It should be noted that energy system 60 can be integrated into all types and sizes of buildings and structures as well as locations requiring energy. As would be understood, system 60 may either include fewer components and systems or may include additional components or systems.

Energy system 60 can integrate any one or more of the heating, cooling, water heating and electrical systems into a mobile and portable unit. As would be understood from the above description, energy system 60 is powered by fuel 18. Using turbine energy generating system 10, energy system 60 can fulfill the electrical, heating, cooling and/or hot water, and/or potable water needs for a location, building or structure.

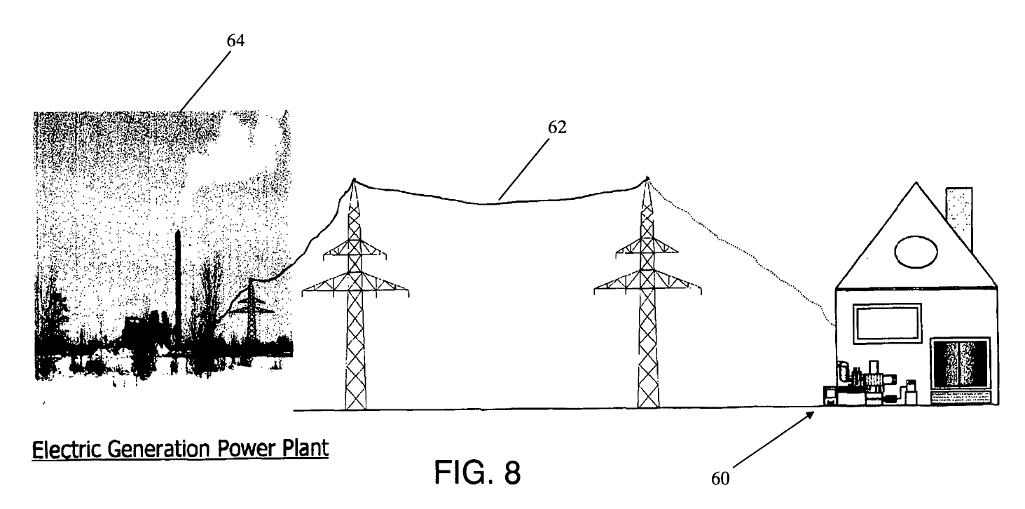

The relationship between house 58, home energy system 60, electric generation power plant 64 and grid 62 is illustrated in FIG. 8. Home energy system 60 can provide at least part of, if not all the electrical needs of a single location, structure or building, such as house 58. Energy system 60 is integrated with grid 62 at a junction box or switchboard controller and meter 30 to distribute electrical load in a location. Either energy system 60 or grid 62 can be the primary system with the other system serving as an auxiliary or support system. When energy system 60 produces more electricity than required, the electrical load can be stored in a storage device, such as some type of battery, or returned back to power grid 62. In systems that are not tied into the electric company, as a system setup located in a remote or third world location, surplus electrical load can be delivered to a specific location over a local grid 62. Alternatively, if surplus electrical load is returned to grid 62, house with surplus electricity can designate a specific house or location to receive the electrical load through the electric company's grid 62. This sharing of electrical loads allows two locations to exchange electrical loads at a cost lower than purchasing from the electric company.

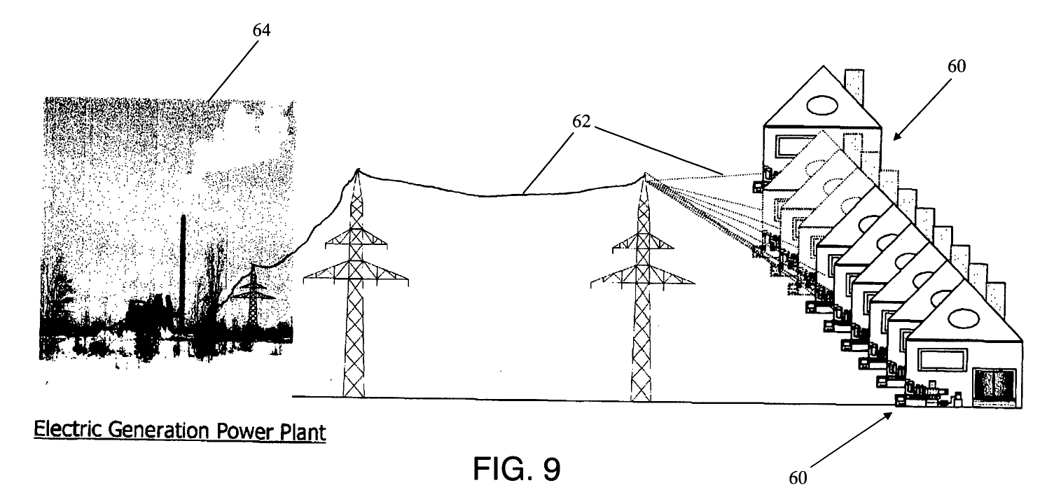

The relationship between a plurality of houses 58 with energy system 60, grid 62, and electric generation power plant 64 is illustrated in FIG. 9. Each house 58 may have energy system 60 to satisfy the electrical needs for that home. However, grid 62 still offers access to electrical power from electric generation power plant 64 to all homes 58. Energy system 60 enables homes to save money since power from the electrical company is often costly. Furthermore, each home 58 with energy system 60 may provide other houses 58 with power if required and desired, as described below. It should be noted that a plurality of locations, structures and building with energy system 60 can also share energy.

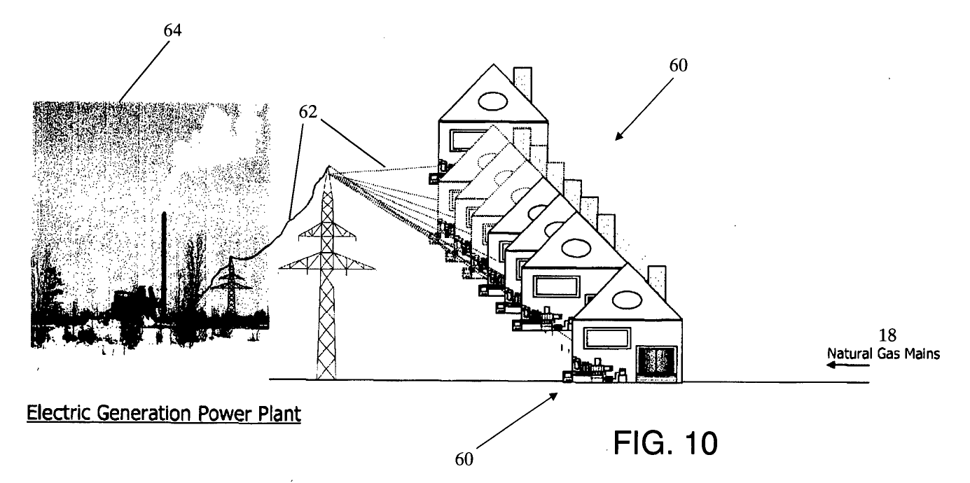

The relationship between a plurality of houses 58 with energy systems 60, grid 62, electric generation power plant 64, and fuel source 18 is illustrated in FIG. 10. Energy systems 60 only require fuel source 18 such as natural gas to provide electrical power, heating and cooling, and/or water heating in a small portable unit.

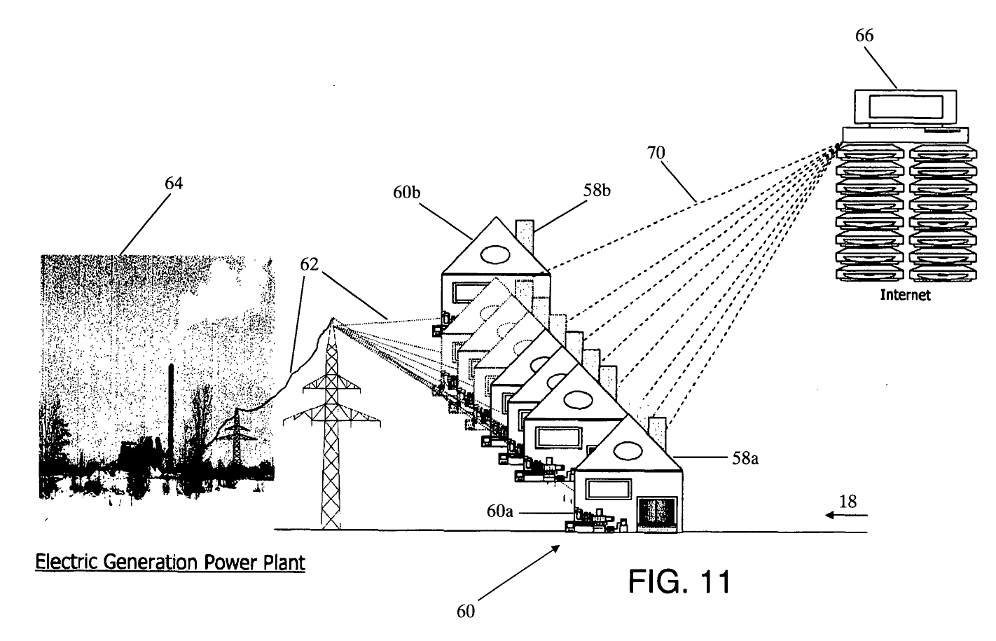

The relationship between houses 58 with energy systems 60, grid 62, electric generation power plant 64, and central controller 66 over network 70 is illustrated in FIG. 11. Central controller 66 communicates with houses 58 over network 70 through each house's switchboard controller and meter 30, which is coupled to energy system 60 over network 70. Network 70 can be the Internet, an Ethernet network, or a wireless network. Central controller 66 can access information such as usage, spending, surpluses and shortages for each energy system 60 through switchboard controller and meter 30. Central controller 66 may control distribution of electrical power over grid 62 and communicate with each energy system 60 to determine the status of each system. Central controller 66 may be configured to track where surpluses exists and draw from surpluses that are accessible and credit houses 58 providing electrical power back to grid 62.

Additionally, network 70 enables communication between a plurality of houses 58. For example, a specific house 58a may either request or offer electricity over network 70 to another house 58b for direct house to house exchange and sale of electricity. The spending and usage between houses, 58a and 58b, may be monitored by central controller 66 or by each house individually. Direct distribution of power between the plurality of houses promotes faster distribution of power with lower pollution than using grid 62.

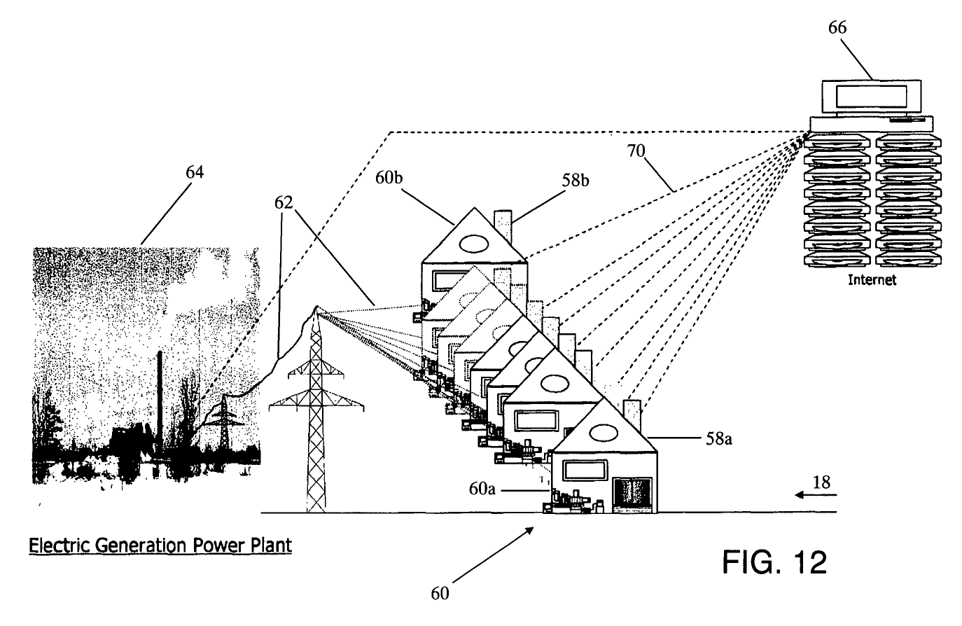

The relationship between houses 58 with energy systems 60, grid 62, electric generation power plant 64 and central controller 66 over network 70 using power wheeling standards is illustrated in FIG. 12. Central controller 66 uses network connection 72 to control distribution of electrical loads over grid 62 from power plant 64 according to the power wheeling standards and policies.

For example, house 58a with energy system 60a may provide surplus electricity to energy system 60b of another house 58b over grid 62 and facilitated by central computer 66. Accordingly, central computer 66 may manage power distribution between plurality of energy systems 60 for faster and more efficient electric distribution and consumption according to power wheeling standards and policies.

Additionally, energy system 60a may provide surplus electrical load back to grid 62 facilitated by central controller 66. Central controller 66 tracks both the usage and spending over network 70 of electric loads over grid 62. Central computer 66 determines the amount of electrical load delivered back to grid 62 from energy system 60a and puts a credit on the account for house 58a, which provided the surplus.

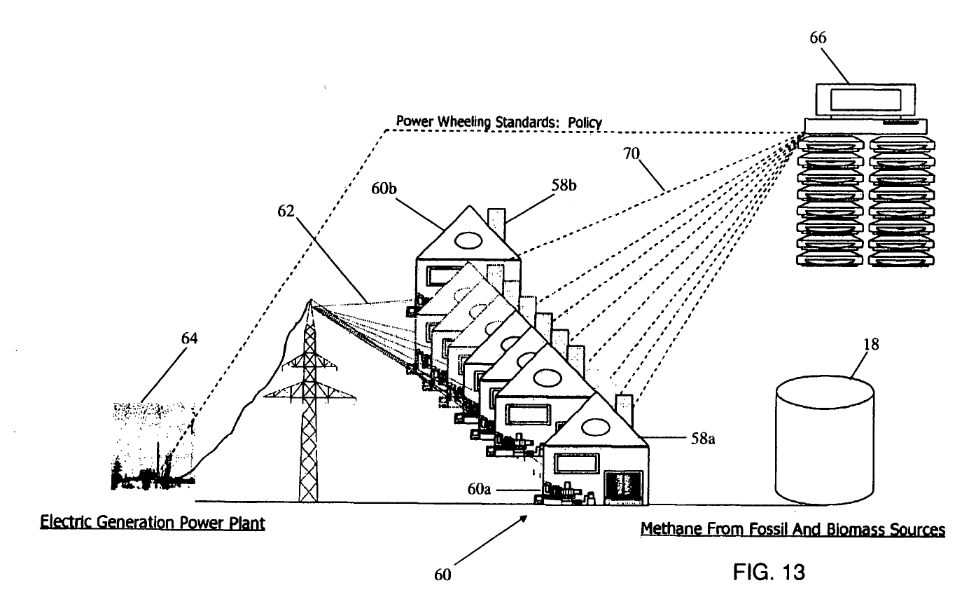

The system setup of FIG. 12 with additional sources of fuel 18 is illustrated in FIG. 13. Fuel 18 may come from methane from fossil and biomass sources. Many types of fuel 18 may be used to power turbine energy generating system 10 of energy system 60 for the production of energy and electrical loads. Energy system 60 may be especially useful in third world countries where power provided by electric generation power plants 64 is erratic and inconsistent leading to “brownouts” and “blackouts.” In many parts of the world, there is a lack of electrical infrastructure of transmission and distribution lines from power plants 64.

Energy system 60 with energy generating system 10 eliminates expensive structural costs to install and deliver products to the consumer over an electrical infrastructure. Accordingly, this invention provides an advantageous alternative to receiving electricity from central power plant 64. Energy system 60 provides a location or plurality of locations with electricity, heating and cooling, and/or hot water, without reliance on a central plant for electricity. Energy system 60 effectively utilizes the exhaust heat from turbine energy generation system 10 to provide heat and improve the overall efficiency of the entire system.

Referring to FIG. 14, the numeral 110 generally designates another embodiment of the turbine energy generating system of the present invention. Similar to the previous embodiments, turbine energy generating system 110 is adapted to convert fuel 118 into electrical power 128 that can be used immediately, stored for later use, or delivered to a network for distribution within the network, such as an electric company grid. In the illustrated embodiment, turbine energy generating system 110 is adapted to generate high pressure, high temperature steam energy 130, which is directed into a turbine 114 to generate electrical power 128 and also to generate, as exhaust, hot water and steam 132.

Turbine energy generating system 110 includes a combustion chamber 112, a turbine 114, and a generator 116, such as an electric generator and inverter. In the illustrated embodiment, turbine energy generating system 110 is particularly suitable for use as a portable unit that is easily transportable between locations and buildings. Similar to system 10, turbine 114 is configured such that it has an output in a range to 1 to 15 kilowatts and more preferably in a range of 5 to 10 kilowatts. Optionally, turbine 114 may have an efficiency of at least 40%, more preferably at least 50%, and more typically, in a range of 50% to 60%.

Fuel 118 is provided to combustion chamber 112, which converts the fuel into gaseous heat energy 120 by igniting the air and fuel mixture. Air or an air/gas mixture is injected into chamber 112 through an inlet port (not shown) to control the rate of combustion in chamber 112.

Similar to fuel 18, fuel 118 may include diesel, gasoline, naphtha, propane, methane, natural gas, wood, coal, biomass, lawn clippings, oil, combustible recyclables, such as tires, plastic, and paper products, biogas, or biodiesels. Located in chamber 112 is a high pressure vessel 112a that holds water 112b, which is heated by gaseous heat energy 120. When gaseous heat energy 120 heats water 112b, water 112b circulates in vessel 112a and produces steam or steam energy 130, including high pressure and high temperature steam or steam energy. The exhaust heat and gas is then exhausted from chamber 112 through outlet 112c, which preferably includes a filter to remove the harmful waste in the exhaust.

Chamber 112 may be an open or closed chamber. In addition, chamber 112 may be closed with the fuel located exteriorly of the chamber and ignited to produce a flame directed onto the chamber rather than in the chamber—in which case the chamber could form the high pressure vessel.

Vessel 112a is in fluid communication with turbine 114 via a conduit 113, which optionally includes a nozzle 113a, such an expansion nozzle, which introduces or injects steam energy 130 into turbine 114 at a higher pressure than the pressure of the steam in chamber 112a or in conduit 113 to increase the output of the turbine 114 for a given steam pressure generated in vessel 112a. Steam energy 130 preferably only undergoes expansion after it is injected into turbine 114.

Steam energy 130 provides steam, optionally high temperature and high energy steam, to the blades of turbine 114, which converts the steam energy into mechanical energy 122. In addition, during the conversion of the steam energy 130 exhaust hot water and steam 132 may also produced. Exhaust water and steam 132 is released from turbine 114, and may be directed into a storage tank for later use or to a water heating system for recycling.

Generator 116 converts mechanical energy 122, which it receives from turbine 114, into electrical energy 128. Generator 116, like generator 16, may include a rotating rotor and a stator. The rotor may be a permanent magnet positioned rotatably within the stator and rotates relative to the stator during operation of turbine 114. Mechanical energy 122 can be transferred to a shaft from turbine 114 to the rotor, so that the shaft, turbine 114 and rotor of generator 116 rotate in unison at speeds, for example, of up to 90,000 rpms. In smaller portable applications though, this speed may be more typically in a range of 500 to 3000 rpms.

Additionally, like turbine energy generating system 10, turbine energy generating system 110 is compatible for integration with other energy systems and systems requiring energy, as discussed above.

Referring to FIGS. 15, 16, 18, and 19, one suitable turbine for turbines 14 and 114 comprises a compact modular turbine that includes a housing 210, a shaft 212, and a paddle wheel 216. Housing 210 includes an inlet 210a, an outlet 210b, and a chamber 218, which is in fluid communication with inlet 210a and outlet 210b. Paddle wheel 216 is located and enclosed in chamber 218 by housing cover 210c and, further is sized such that its outermost diameter is dimensioned to contact the inner surface of chamber 218. In other words, the outermost diameter of paddle wheel 216 is approximately equal to the diameter 218a of chamber 218.

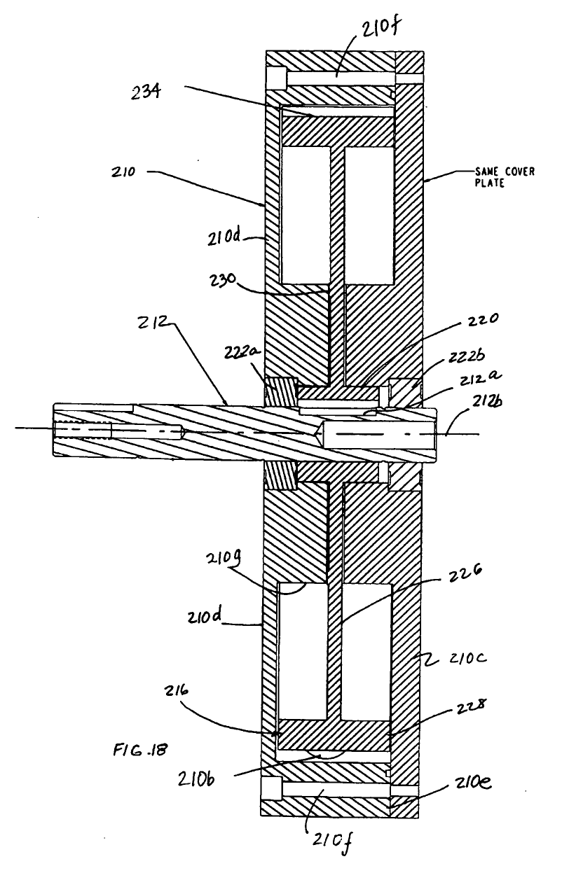

As best seen in FIG. 18, shaft 212 extends through housing 210 and is supported in housing wall 210d and housing cover 210c in bushings 222a and 222b and further projects outwardly from housing 210 for coupling to the shaft of the generator. Further, wheel 216 is mounted to shaft 212 in chamber 218 and captured in housing 210 closely adjacent to wall 210d of housing 210 by housing cover 210c , which is secured to housing perimeter wall 210e by fasteners that extend into respective mounting openings 210f provided in housing 210.

Paddle wheel 216 is mounted and rotatably coupled to shaft 212 by a collar 220, which includes a keyway 220a for receiving a key 220b that extends into keyway 212b provided on shaft 212 to thereby rotatably couple wheel 216 to shaft 212. In this manner, when paddle wheel 216 rotates in housing 210, shaft 212, which is supported in housing 210, will be driven to rotate about its longitudinal axis 212b.

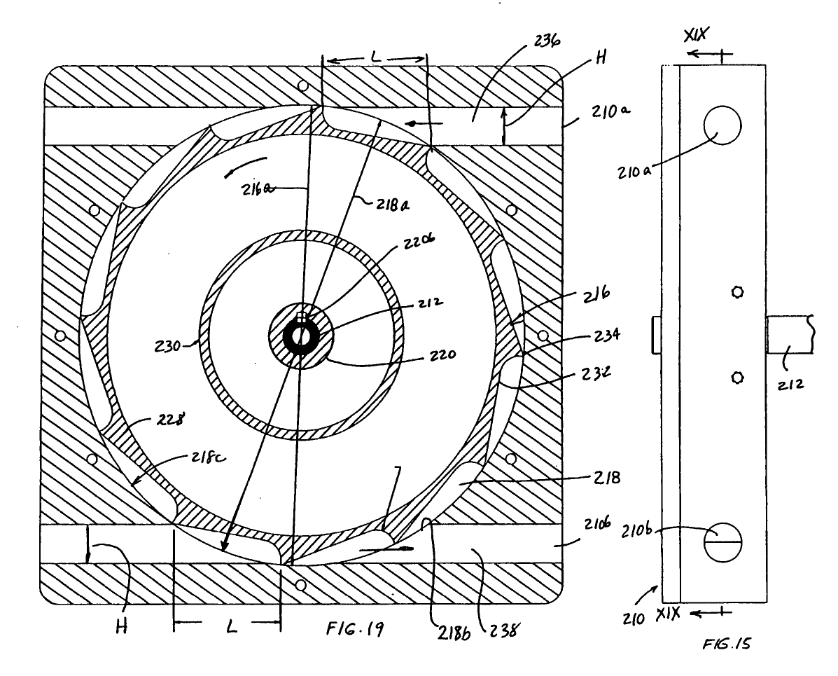

As best seen in FIGS. 16, 17, and 18, paddle wheel 216 includes a central circular plate 226 with an enlarged annular flange 228 at its outer periphery. Plate 226 further includes an annular spacer ring 230, which is provided inwardly of flange 228 and which provides a bearing surface for wheel 226 for contacting housing wall 210 at central annular seat 210g. Enlarged annular flange 228 includes a plurality of flattened generally V-shaped notches 232 formed in its outer periphery to thereby form a plurality of fins 234 that form the turbine blades, which make contact with the inner surface 218b of cavity 218.

As best understood from FIGS. 16, 18, and 19, cavity 218 is cylindrical in shape and interests with the cylindrical passageways 236 and 238, which exit housing 210 to form inlet 210a and 210b, respectively. In the illustrated embodiment, the upper right end (as viewed in FIG. 19) of passageway 236 is open to form inlet 210a, while the upper left end of passageway 236 is closed. Similarly, the lower right end (as viewed in FIG. 19) of passageway 238 is open to form outlet 210b, while the lower left end of passageway 238 is closed. It should be understood that outlet locations may be provided at the upper left end of passageway 236 (with both ends of passageway 238 closed) or at the lower left end of passageway 238 (with the right end of passageway 238 and left end of passageway 236 being closed). It should be understood that the references to right, left, upper, and lower are only used in the context of the relative positions in the drawings and are not intended to be limiting in anyway.

Referring again to FIG. 19, cylindrical passageways 236 and 238 intersect cavity 218 at its outer perimeter 218c. As noted above, with the illustrated inlet/outlet configuration one end of each passageway (236, 238) is sealed so that when the gaseous heat energy (20, 120) is directed into the inlet the gas will impinge on the fins to rotate the wheel 216 in cavity 218, which gas is then exhausted through the end of passageway 238 that forms outlet 210b.

As best seen in FIG. 19, in order to efficiently transfer the gaseous heat energy into rotational movement of wheel 216, the spacing between fins 234 is such that fins 234 straddle the intersections of passageways 236, 238 with cavity 218. As a result, the spacing between the fins is proportional to the height H of the passageways and the length L of the intersection of the passageways with cavity 218.

As previously described, the turbine shaft (212) of the turbine (14 or 114) drives the generator (16 or 116). In the present invention, in some applications, for example in low pressure applications, it may be preferable to reduce the drag on the generator. In these applications, the generator is constructed without an iron core. This eliminates the residual magnetism and, therefore, reduces the torque necessary to drive the generator.

Further, as would be understood, the generators (16 or 116) may be configured to generate DC or AC current. In both applications, the generator shaft is mounted with a plurality of magnets, such as rare earth magnets. The number of magnets and the shape of the magnets may be varied to suit each application.

In the DC application, the magnets are mounted such that the same poles (e.g. the south poles) are directed inwardly to the shaft, while the other poles (e.g. the north poles) are facing outwardly. The magnets are then located between coils, typically formed from copper wiring. Again, the size, the number of coils, and the gage of the coils may be varied depending on the application. Further, the coils may be coupled together in parallel or in series. Thus, when the generator shaft is driven, which is either coupled to the shaft of the turbine, or is formed by an extension of the shaft of the turbine, a DC current will be generated by the coils.

In order to maximize the current collection from the generator, the coils are connected in parallel and each coil circuit may include a diode, which acts as a valve to prevent current from flowing in the reverse direction.

With the AC application, the magnets are mounted to the generator shaft such that one group of magnets have their south poles directed inwardly toward the shaft and the other group has their north poles facing outwardly from the shaft.

In either application, the generator may be coupled to the end load (that is the home or energy system to which the generator is supplying energy) through a switching capacitor circuit, which reduces if not eliminates the load variation on the generator due to the variation in the power usage at the end load. The switching capacitor circuits are well known and typically include at least two capacitors, a logic controller that is coupled to the generator and to the capacitors and selectively switches between the two capacitors, a second controller that is coupled to first controller through the capacitors, and an inverter that couples the second controller to the end load. The first controller switches between the two capacitors when one of the capacitors reaches saturation. In this manner, the generator is isolated from the variation in load at the end load.

While several forms of the invention have been shown and described, other forms will now be apparent to those skilled in the art. For example, as described above, anyone of the systems could incorporate a water cooling/and or heating extraction system to cool the combustion chamber. For example, the combustion chamber may be cooled with water with a heat exchange surface that induces water boiling-into steam. Such generated steam could then be condensed yet in another heat exchanger to produce liquid potable water from a variety of initial cooling water sources. This could be quite a novel advantage for the application of such turbine electric systems, whether using steam to generate the turbine driving energy or natural gas combustion, where safe drinking water is desired.

Therefore, it will be understood that the embodiments shown in the drawings and described above are merely for illustrative purposes, and are not intended to limit the scope of the invention, which is defined by the claims, which follow as interpreted under the principles of patent law including the Doctrine of Equivalents.

The embodiments of the invention in which I claim an exclusive property right or privilege are defined as follows:

1. A turbine energy generating system comprising:
a combustion chamber for converting fuel into energy by igniting an air and fuel mixture;
a turbine for converting energy produced by said combustion chamber into mechanical energy; and
a generator for converting mechanical energy produced by said turbine into electrical energy in the range of 1 to 15 kilowatts.

2. The turbine energy generating system of claim 1, wherein said turbine energy generating system is portable.

3. The turbine energy generating system of claim 1, wherein said combustion chamber includes a high pressure vessel for holding water, said combustion chamber heating the water to produce steam energy, said turbine converting steam energy produced by said combustion chamber into mechanical energy.

4. The turbine energy generating system of claim 1, wherein said turbine comprises a nanoturbine.

5. The turbine energy generating system of claim 1, wherein said turbine energy generating system operates in an efficiency range from 50% to 60%.

6. The turbine energy generating system of claim 5, wherein said turbine and said generator produce 5 to 10 kilowatts.

7. The turbine energy generating system of claim 6, wherein the generator comprises an electric generator, the electric generator producing alternating electric current during operation of the turbine energy generating system.

8. The turbine energy generating system of claim 7, wherein the fuel is selected from the group consisting of diesel, gasoline, naphtha, propane, methane, natural gas, wood, coal, biomass, lawn clippings, oil, combustible recyclables, biogas, and biodiesels.

9. The turbine energy generating system of claim 8, further comprising
an exhaust passage downstream from said turbine delivering high temperature exhaust air from said turbine; and
a heat exchanger receiving high temperature exhaust air from said exhaust passage for heat transfer.

10. The turbine energy generating system of claim 9, further comprising an air conditioning system coupled to said heat exchanger.

11. The turbine energy generating system of claim 10, further comprising a water heating system coupled to a heat exchange exhaust for releasing lower temperature exhaust air; said water heating system converting tap water into hot water.

12. The turbine energy generating system of claim 1 further in combination with an energy system, wherein said turbine generating system provides energy to said energy system.

13. The turbine energy generating system of claim 13 wherein said energy system comprises an electrical distribution system.

14. The turbine energy generating system of claim 13 wherein said energy system comprises a heating system.

15. The turbine energy generating system of claim 13 wherein said energy system comprises a cooling system.

16. The turbine energy generating system of claim 13 wherein said energy system comprises a water heating system.

17. An energy system comprising:
a central controller;
a plurality of said turbine energy generating systems according to claim 1; and
a network connecting said central controller and said plurality of turbine energy generating systems;
wherein said central controller communicates with said plurality of turbine energy generating systems over said network.

18. The energy system of claim 17 wherein said central controller communicates with said plurality of turbine energy generating systems to communicate information such as usage and spending through an electric grid over said network.

19. The energy system of claim 18 wherein said central controller communicates with at least one of said plurality of turbine energy generating systems to return power to said electric grid.

20. The energy system of claim 17 wherein said plurality of turbine energy generating systems communicate with each other.

21. The energy system of claim 20 wherein at least one of said turbine energy generating systems provides a power load to another at least one of said turbine energy generating systems.

22. The energy system of claim 21, wherein said network comprises an internet network using policy parameters from power wheeling standards.

23. A method of generating power from a turbine energy generating system comprising:
converting fuel into gaseous heat energy by igniting an air and fuel mixture in a combustion chamber;
converting gaseous heat energy produced in the combustion chamber into mechanical energy with a turbine; and
converting mechanical energy produced by the turbine into electrical energy in the range of 1 to 15 kilowatts with a generator.

24. The method of claim 23 further comprising:
generating power from said turbine energy system with an efficiency of at least 40% to 60%.

25. The method of claim 24 further comprising:
producing 5 to 10 kilowatts from said turbine and said generator.

26. The method of claim 23 further comprising:
cooling the combustion chamber with a heat exchange surface; and
boiling water into steam with the heat exchange surface.

27. The method of claim 26 further comprising:
condensing said steam generated by said boiling water in another heat exchanger; and
producing liquid potable water.

28. The method of claim 27 further comprising:
selecting the fuel from the group consisting of diesel, gasoline, naphtha, propane, methane, natural gas, wood, coal, biomass, lawn clippings, and oil.

29. The method of claim 28 further comprising:
delivering high temperature exhaust air from said turbine through an exhaust passage downstream from said turbine; and
receiving in a heat exchanger high temperature exhaust air exhausted from said turbine for heat transfer.

30. The method of claim 29 further comprising:
coupling said heat exchanger to an air conditioning system.

31. The method of claim 30 further comprising:
coupling a heat exchange exhaust with a water heating system for releasing lower temperature exhaust air; and
converting water into hot water in said water heating system.

32. The method of claim 31 further comprising:
providing a central controller;
providing a plurality of turbine energy generating systems;
networking over a network the central controller and the plurality of turbine energy generating systems; and
communicating between said central controller with the plurality of turbine energy generating systems over the network.

33. The method of claim 32 further comprising:
communicating information relating to usage through an electric grid between the central controller and the plurality of turbine energy generating systems over the network.

34. The method of claim 33 further comprising:
communicating with at least one of the plurality of turbine energy generating systems to return power to the electric grid by the central controller.

35. The method of claim 34 further comprising:
enabling a first turbine energy generating system to provide a power load to a second turbine energy generating system through the electrical grid over the network by the central controller.

36. The method of claim 35 further comprising:
using policy parameters from power wheeling standards over an internet network.

37. The method of claim 36 further comprising:
coupling the turbine energy generating system with a plurality of compatible energy systems; and
providing energy wherein said plurality of compatible energy systems from the turbine generating system for operation of said plurality of compatible energy systems.

38. The method of claim 37 further comprising:
coupling the turbine energy generating system with an electrical distribution system.

39. The method of claim 37 further comprising:
coupling the turbine energy generating system with a heating system.

40. The method of claim 37 further comprising:
coupling the turbine energy generating system with a cooling system.

41. The method of claim 37 further comprising:
coupling the turbine energy generating system with a water heating system.

42. A method of generating power from a turbine energy generating system comprising:
converting fuel into gaseous heat energy by igniting an air and fuel mixture in a combustion chamber;
heating water with gaseous heat energy from the combustion chamber;
said heating generating steam energy;
converting steam energy produced in the combustion chamber into mechanical energy with a turbine; and
converting mechanical energy produced by the turbine into electrical energy in the range of 1 to 15 kilowatts with a generator.

43. The method of claim 42 further comprising:
generating power from said turbine energy system with an efficiency of at least 40%.

44. The method of claim 43 further comprising:
generating power from said turbine energy system with an efficiency range from 50% to 60%.

45. The method of claim 43 further comprising:
producing 1 to 10 kilowatts from said turbine and said generator.

46. The method of claim 45 further comprising:
producing alternating electric current during operation of the turbine energy generating system with the generator.

47. The method of claim 42 further comprising:
cooling the combustion chamber with a heat exchange surface; and
boiling water into steam with the heat exchange surface.

48. The method of claim 47 further comprising:
condensing said steam generated by said boiling water in another heat exchanger; and
producing liquid potable water.

49. The turbine energy generating system of claim 1 further in combination with an switching capacitor circuit, said generator coupled to an end load through said switching capacitor circuit, and said switching capacitor circuit isolating the variation in load at the end load from the generator.

50. The turbine energy generating system of claim 1 wherein said generator does not include an iron core.
